(19) United States
(12) Patent Application Publication
(10) Pub. No.: US 2023/0338227 A1
(43) Pub. Date: Oct. 26, 2023

(54) A Wearable Muscle Tendon Vibration Device for Rehabilitation

(71) Applicant: University of Manitoba, Winnipeg (CA)

(72) Inventors: Niyousha Mortaza, Toronto (CA); Cheryl Glazebrook, Winnipeg (CA)

(21) Appl. No.: 18/041,732

(22) PCT Filed: Sep. 29, 2021
(86) PCT No.: PCT/CA2021/051354

§ 371 Date: Feb. 17, 2023

Related U.S. Application Data
(60) Provisional application No. 63/086,838, filed on Oct. 2, 2020.

(51) Int. Cl. A61H 23/02

(52) U.S. Cl. CPC A61H 23/0263; A61H 2201/5084; A61H 2201/5002; A61H 2201/165; A61H 2201/5005; A61H 2201/1638; A61H 2205/06; A61H 2201/0192

(57) ABSTRACT

A wearable rehabilitation device features a wearable support sized and shaped for worn fitting thereof over a body part of a patient, one or more vibratory stimulators on the wearable support that are positioned and operable to stimulate muscle tendon tissue of said body part of the patient, and one or more accelerometers on the wearable support configured to generate output signals responsive to vibration of said one or more vibratory stimulators. A controller compares output signals from the accelerometer against a targeted vibrational frequency, and adjusts operating conditions of the stimulator based on detected disagreement to achieve the targeted frequency for optimal therapeutic effect.

### FIELD OF THE INVENTION

The present invention relates generally to therapeutic devices, and more specifically to vibration devices for stimulating muscle tendons for rehabilitation therapies.

### BACKGROUND

Sense of limb position is necessary for humans to control their limbs without looking at the moving limb. Sense of limb position improves with practice in healthy individuals. Sense of limb position will be defected or deteriorated as a result of injuries or deficiencies in the nervous system such as stroke, diabetes, and aging. Various robotic rehabilitative devices, and other physical rehabilitation treatments, have been proposed for improving sense of limb position.

Among such developments, there has been an increase in the evidence in the past ten years for using muscle tendon vibration (MTV) to stimulate la afferents for rehabilitation of conditions with proprioception deficiency and muscular spasticity (Aman, Elangovan, Yeh, & Konczak, 2014; Mortaza et al., 2019). The findings of a literature review and meta-analysis by Mortaza et al. showed that for therapeutic purposes the amplitude and frequency of MW should be about 0.5 mm or higher and 80-120 Hz respectively (Mortaza et al., 2019). These MTV characteristics are appropriate because muscle spindles, that are the main target of vibration treatment, have shown to be sensitive to vibration within the above mentioned amplitude and frequency ranges (Roll & Vedel, 1982; Roll, Vedel, & Ribot, 1989). Most of the studies that used MTV have not reported a quantitative method to measure the vibration parameters before or during the experiments. For the vibration to be therapeutic, it is essential that the amplitude and frequency fall within the above-mentioned range. Also, there is no standard and portable method established for measuring vibration characteristics.

Hence, it would be desirable to provide a portable and wearable vibration device with adjustable vibration frequency and amplitude.

### SUMMARY OF THE INVENTION

According to one aspect of the invention, there is provided a wearable rehabilitation device comprising:
a wearable support sized and shaped for worn fitting thereof over a body part of a patient; and
supported on said wearable support:
   one or more vibratory stimulators operable to stimulate muscle tendon tissue of said body part of the patient; and
   one or more accelerometers configured to generate output signals responsive to vibration of said one or more vibratory stimulators.

According to another aspect of the invention, there is provided a wearable rehabilitation device comprising:
a wearable support sized and shaped for worn fitting thereof over a body part of a patient; and
supported on said wearable support:
   a first vibratory stimulator positioned on said wearable support at a first location thereon that is arranged to overlie a first muscle tendon of said body part of the patient when said wearable support is donned in a worn position thereon; and
   a second vibratory stimulator positioned on said wearable support at a second location thereon that is arranged to overlie a second muscle tendon of said body part of the patient when said wearable support is donned in the worn position thereon.

### BRIEF DESCRIPTION OF THE DRAWINGS

One embodiment of the invention will now be described in conjunction with the accompanying drawings in which:

FIG. 1 illustrates a wearable wrist-worn muscle tendon vibration device of the present invention.

FIG. 2 illustrates the device of FIG. 1 in a worn position on a patient's wrist.

FIG. 3 is a combined schematic flowchart and block diagram illustrating electronic componentry and associated functionality of the device of FIGS. 1 and 2.

FIG. 4 is a Bland-Altman plot for vibrational frequency from a case study performed with an early prototype of the present invention.

FIG. 5 is a Bland-Altman plot for vibrational amplitude from the same case study.

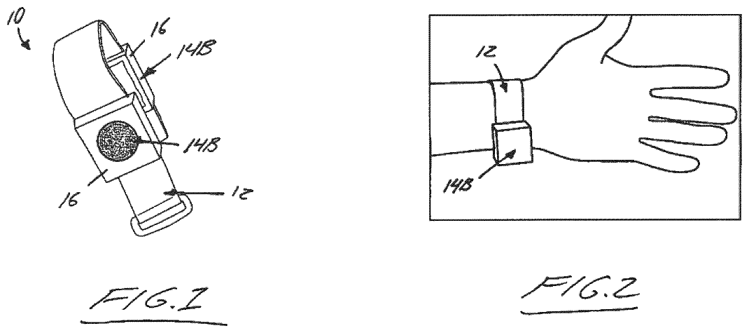

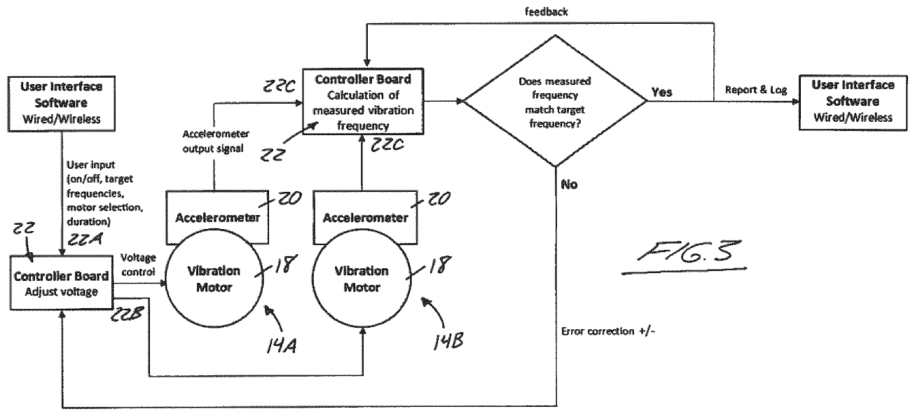

### DETAILED DESCRIPTION

The drawings show a wrist-worn embodiment of a wearable muscle tendon vibration device of the present invention. The illustrated device 10 features an adjustable-length wristband 12 on which there are mounted a pair of vibratory units 14A, 14B for respective vibrational stimulation of flexor and extensor muscle tendons on opposing anterior and posterior sides of a patient's wrist. In a worn position of the device 10, the wristband 12 forms a closed loop around the patient's wrist, with an anterior half of said closed loop spanning across the anterior side of the patient's wrist, and a complimentary posterior half of said closed loop spanning across the opposing posterior side of the patient's wrist. One of the two vibratory units 14A resides on the anterior half of the closed wristband loop, and thus may be referred to as an anterior vibratory unit 14A, while the other of the two vibratory units 14B resides on the posterior half of the closed wristband loop, and thus may be referred to as a posterior vibratory unit 14B.

The adjustability of the wristband 12 refers to an ability to adjust the size of the closed loop formed thereby around the wearer's wrist, similar to a watchband or the like, whereby the wristband 12 size can be adjusted to an appropriate patient-specific size, and further fine-tuned as necessary to accommodate slight variations in that patient's wrist size over time, for example whether attributable to weight gain, weight loss, or general swelling and contraction. During use of the device, the wristband is worn sufficiently tight to hold each vibratory unit 14A, 14B snug against the patient's skin in overlying relation to the respective flexor or extensor muscle tendons that are to be stimulated by that vibratory unit.

Each vibratory unit 14A, 14B comprises a respective housing 16 in which there is contained both a vibrational stimulator 18, and an accompanying vibration sensor 20 operable to measure one or more characteristics (e.g. frequency and/or amplitude) of the vibration created by the vibrational stimulator. In one non-limiting embodiment, the vibrational stimulators 18 are eccentric rotating mass (ERM) vibration motors, and the vibration sensors 20 are accelerometers whose variable output signal denotes a measured acceleration along an axis, from which the vibration frequency induced by the respective vibration motor 18 can be derived by an electronic controller 22 of the device, at least part of which may be embodied by a shared microcontroller 22 connected to both of the accelerometers 20 and both of the vibration motors 18. One or both vibrational units may incorporate a clamp or other securement mechanism that can be selectively switched between secured and released states on the wristband to enable sliding or other relocation of the vibrational unit among different locations along the wristband's length, thus enabling optimal positioning of the vibrational units relative to one another to best fit a particular patient's anatomy.

The controller 22 can use the measured vibrational frequency as feedback by which to adjust operating conditions of the vibration motors 18 to achieve a targeted vibrational frequency for optimal therapeutic effect on the patient's muscle tendons. Preferably the targeted vibrational frequency is in the range of 70-120 Hz. A specific targeted vibrational frequency value may be input to the controller by the patient, or by a caregiver (e.g. physiatrist or physical therapist), and the controller and accelerometers cooperate to ensure the targeted vibrational frequency value is substantially achieved and maintained, at least within a suitable accuracy threshold. This cooperative functionality between the vibration sensors and the controller is a significantly beneficial aspect of the disclosed invention, as for a given rotation speed of a vibration motor, the actual induced vibrational frequency applied to the patient can vary, for example according to the particular patient's anatomy, and according to the tightness by which the vibrational unit is held against the user's skin in the worn position of the device. Accordingly, accurate control over the operating voltage and resulting rotational speed of the vibration motor is not alone sufficient to ensure that a particularly targeted vibrational frequency is actually achieved, without the additional feedback implemented in the presently disclosed invention by the inclusion of the accelerometers and associated motor-adjustment function of the controller.

The controller 22 has at least one user-control input 22A through which user input signals indicative of targeted vibrational frequencies are received by the microcontroller 22. This may be accomplished in various ways, for example through one or more control buttons found on-board the device 10 to allow the user to cycle unidirectionally or bidirectionally through a predefined selectable frequency range, or through a wireless transceiver (e.g. Bluetooth transceiver) found on-board the device 10 to receive such user control signals from a separate remote device, e.g. a smartphone or tablet computer equipped with a cooperating software application. The software application, composed of executable statements and instruction stored in a non-transitory computer readable memory of said remote device for execution by a data processor thereof, is configured to present a graphical user interface (GUI) on a display screen of said separate device (e.g. typically touchscreen GUI operating on a touch-responsive display screen of said separate device), with which the user (patient or caregiver) can interact to input targeted vibrational frequencies and other user input relative to operation of the device 10. In the interest of brevity, this software application and its user interface are collectively referred to herein as the interface software.

The user input signals may optionally include the specification of two different respective target frequencies to be assigned to the two vibratory units. In addition to identification of target frequencies, other user input signals may include simple on/off commands for activating and deactivating the two vibration motors, unit-selection commands indicating which of the two vibratory units to operate (one, the other, or both) in a given therapy session, and session timing commands denoting a particular time duration for which to run one or both of vibratory units for a given therapy session.

The microcontroller 22 has two control outputs 22B through which the operating voltages applied to the two vibration motors 18 from an on-board DC power supply of the device are controlled in order to vary the rotational speeds of the vibration motors 18, thereby controlling the resulting frequencies and amplitudes of the vibrations induced by said motors 18. In a non-limiting example, output control signals from the control outputs 22B may be pulse width modulation (PWM) signals, for example each applied to the gate terminal of a transistor in a simple respective switching circuit connected between the DC power supply and a respective one of the motors to cycle the motor's supply voltage on and off to control the average voltage applied thereto. Alternatively, the output control signals from the control outputs 22B may be inputted via motor driver circuitry of a different type in order to likewise vary the applied voltage and resulting rotational speed of the vibration motors, whether such motor driver circuitry is assembled from discrete components or embodied in one or more integrated circuits (e.g. one integrated circuit (IC) shared by the two vibration motors, or two ICs respectively driving the two vibration motors).

The microcontroller 22 has two feedback inputs 22C through which the output signals from the two accelerometers are respectively received, and from which the microcontroller derives the actual respective frequencies of the induced vibrations from two vibration motors. The microcontroller compares these measured actual frequencies against the respective target frequencies for the two vibration motors, and in the event of disagreement therebetween, at least beyond an acceptable threshold, adjusts the output control signals in order to either increase the applied motor voltage, and thereby increase the motor speed, if the measured vibration frequency is too low; or decrease the applied motor voltage, and thereby decrease the motor speed, if the measured vibration frequency is too high.

At the start of a therapeutic session, the micro-controller receives an “on” command, and optionally also a unit-selection command indicative of which of the vibration units to run during this session, and/or a respective user-inputted target frequency for each vibratory unit that is to be run during this session. In one implementation, the microcontroller may be programmed to run both vibration motors by default if no specific unit-selection command is received, and to run the vibration motors at a default rotational speed (determined by a default motor voltage applied via a default control signal) if no specific user-inputted target frequency is received. Motor control signals from the two control outputs 22B initiate operation of one or both vibration motors (depending on the unit-selection command, if received) at an initial motor voltage dictated by either a user-inputted target frequency signal, if received, or by the default rotational speed. At this point, the microcontroller begins monitoring the accelerometer outputs signals received at the respective feedback input for each running vibratory unit, and derives the measured actual vibration frequency therefrom, and measures this measured actual vibration frequency against the currently assigned target frequency for the respective vibratory unit (whether a user-inputted target frequency, or default frequency). If there is disagreement, for example beyond a predetermined threshold, between the measured actual vibration frequency of either vibratory unit and the respective target frequency assigned thereto, then the microcontroller applies a correction to the respective motor control signal to increase or decrease the applied motor voltage of that vibratory unit.

In the illustrated flowchart example, only once agreement is reached, within a predetermined threshold, between the measured actual vibration frequency and the respective assigned target frequency for each operating vibration unit, is an external confirmation signal then sent to the interface software to record, for session data logging purposes, the start of a therapeutic session at the targeted frequency. At the same time, this detected agreement in actual and targeted vibration frequency can be used by the microcontroller 22 to start a countdown timer that denotes an intended duration of the therapeutic session. Once the timer expires, the microcontroller 22 terminates operation of the running vibration motor(s), which may also be reported to the interface software as a session termination signal denoting an end of the current therapeutic session, for said aforementioned session data logging purposes. Throughout the full duration of the session, the output signal from the accelerometer of each running motor is monitored and compared against the assigned target frequency for that motor, and the comparison used to appropriately adjust the motor control signals as required in order to maintain the actual vibration frequency within an acceptable agreement threshold of the assigned target frequency.

While the illustrated embodiment employs a wrist strap as a wearable support for the two vibratory units, it will be appreciated that the vibratory units may alternatively be supported on a wearable support of another size, shape or type in order to fit on a different body part of the patient. Additionally, though the illustrated embodiment has two vibratory units respectively positioned to respectively overlie flexor and extensor muscle tendons of two antagonist muscle-tendon groups reside on opposing sides (e.g. posterior and anterior) of the body part in question, it will be appreciated that the quantity of vibrational units may be varied (to as few as one, or to more than two) in other embodiments.

The coupling or pairing of the accelerometers with the vibration motors to calculate the vibration frequency is a significant aspect of the disclosed device. Knowing the vibration frequency is important because different ranges of vibration frequencies have different effects on the sensorimotor system. The ability to adjust the specific vibration frequency allows users to customize the settings of the device for specific therapeutic needs of different patient populations. Individual differences in anatomy and day-day variation in how much tension is applied to the wrist band can lead to differences in the vibration frequency achieved at a given voltage. The ability to control the specific vibration frequency allows users to be confident that the set vibration frequency is the actual frequency applied and therefore the set vibration frequency will have the desired therapeutic effects.

Using a wearable device is cost effective because individuals can learn to use the device independently of a clinical setting. One non-limiting example of a particular useful application of the device is in improving the sense of limb position in older adults or individuals who have suffered a stroke. Wearing the device for a few hours per day is anticipated to have motor rehabilitative effects that can be complementary to physical therapy and/or medication-based treatment. In addition to being wearable and having neurophysiologic benefits, the vibration frequency applied is adjustable and accurately monitored through the session logging functionality, both of which may be important features for reliably achieving the therapeutic intent of the device. To measure and control vibration frequency, an accelerometer sensor will be attached to the vibration motors. The device may be offered in two versions: Alpha and Beta. The Alpha version may have lesser customization capability, with a set of general settings and a simplified version of the interface software to change between a few pre-set modes. This version would be intended as an off-the shelf medical device to improve ease of use for older adults. The Beta version may be similar in general design to the Alpha version, but more customizable with additional settings available in the interface software that can be prescribed and adjusted by a specialized caregiver (physiatrist, physical therapist, etc.) This version will be more appropriate for therapists to use with patient populations, such as in post-stroke scenarios.

### Experimental Support

Most prior studies that used MTV had not reported a quantitative method to measure the vibration parameters before or during the experiments. Also, there was no standard and portable method established for measuring vibration characteristics. Hence, a case study was carried out, whose objectives current study were: i) designing a portable vibration device with adjustable vibration frequency and amplitude; ii) describing the characteristics of the movements of the vibration motor; iii) exploring the feasibility of using an affordable accelerometer to measure vibration characteristics. When using Eccentric rotating mass (ERM) vibration motors, the tightness of the contact of the motor against the skin can easily affect the vibration amplitude and frequency. So, in order to be certain that the vibration experience is within a therapeutic range, in the present study an affordable method was developed to measure vibration parameters using an accelerometer. To validate the accelerometer method, acquired vibration parameters using the accelerometer were compared with the outcomes measured by a gold standard method using a high-end motion capture system.

In this case study, a prototype muscle tendon vibration band was designed. In order to generate the vibration that stimulates the muscle spindles, two ERM vibration motors were mounted on the participant's wrist with a Kinesiology tape. A wearable Arduino-compatible microcontroller along with a motor driver (Adafruit Industries, New York, NY, USA) was used to control the vibration motors. In order to choose the appropriate vibration motor different vibration motors with different voltage inputs were tested using Optotrak motion capture system (Northern Digital Inc., Canada) until the precise vibration parameters were acquired.

The accelerometer used in the current study was ASXL326 analogue accelerometer with a sensitivity of ±16 g. Acceleration data was read and recorded at sampling rate of 10000 Hz using 2 CED Power1401 data acquisition interface (Cambridge Electronic Design, UK). To calibrate the accelerometer, a level was used to align the accelerometer in the positive and negative Z-axis directions to acquire the accelerometer voltage output for positive and negative 1g m/s2. An Optotrak 3D Investigator motion analysis system was used as the gold standard measurement method to compare and validate the measurements of the accelerometer. In order to be able to measure small vibration amplitude (i.e. <1 mm) of the motor using the Optotrak, the motor had to be placed at the optimal angle and distance to the Optotrak. That is, the vibration movement was oriented in the Z-axis and in front of the Optotrak measurement volume, which was 1.5 meter from the cameras. Optotrak data was sampled at 900 Hz. Both infrared light emitting diode (IRED) sensors of the Optotrak and the accelerometer were secured to the vibration motor. The vibration motor was mounted on one participant's wrist using the kinesiology tape. The participant's wrist was supinated, with their limb perpendicular to the Optotrak. The Optotrak recorded the kinematic data of the vibration movement in the Z-axis. The motor vibrated at five different intensities presented as percentage of the maximum input voltage capacity for the motor: 55%, 65%, 75%, 85%, 100%. Five sets of 30-second trials were conducted for each of the five intensities (total of 25 trials) while the Optotrak and CED simultaneously recorded the vibration data.

The acceleration data from the accelerometer was filtered and double integrated to acquire the amplitude of vibration. After each integration, bandpass Butterworth filters (50-150 Hz) were used to minimize noise and DC component in the accelerometer signal. The bandwidth of the filter was determined based on the frequency content analysis of three minutes of recording at 0-100% vibration intensities. Moreover, the frequency content of the vibration was assessed using the acceleration data. Filtering, data reduction and analysis were performed using a custom software designed in MATLAB (The MathWorks Inc., US). The main dependant variables were peak-to-peak amplitude of vibration and frequency of the vibration measure by both Optotrak and accelerometer. The average vibration frequency and amplitude data from each 30-second trial was used for data analyses. That is, the amplitude and frequency data from the total of 25 trials for the five vibration intensities (55%-100%) were used for statistical analyses. To compare and validate the accelerometer method with the Optotrak, an independent sample t-test was used to compare the mean of the variable acquired with these methods. Moreover, Bland-Altman plots were generated. In these graphs the difference between the measurements of the two methods was plotted against the mean of these measurements using the two methods (Bland & Altman, 1986). Bland-Altman plots help evaluate the bias of the mean difference of the two methods and to define an agreement interval within which 95% of these differences fell (Bland & Altman, 1986; Giavarina, 2015). Upper and lower levels of agreement were calculated as ±1.96 standard deviation from the mean difference (Giavarina, 2015). Pearson coefficient was also used in order to assess the correlation of the parameters obtained from the two methods. All statistical analyses were performed with SPSS v23 (Armonk, NY: IBM Corp) and Excel.

TABLE 1
Means and standard deviations (SD) of vibration amplitude and
frequency, using the data from five trials for each vibration
intensity, measured by the accelerometer and Optotrak

| | Frequency | | Amplitude | |
|---|---|---|---|---|
| | (Hz, Mean ± SD) | | (mm, Mean ± SD) | |
| Vibration | | Acceler- | | Acceler- |
| intensities | Optotrak | ometer | Optotrak | ometer |
| 55% | 77.3 ± 1.3 | 77.3 ± 1.2 | 0.175 ± 0.059 | 0.197 ± 0.026 |
| 65% | 83.8 ± 1.8 | 83.8 ± 1.8 | 0.257 ± 0.038 | 0.208 ± 0.014 |
| 75% | 85.7 ± 0.5 | 85.7 ± 0.6 | 0.365 ± 0.137 | 0.207 ± 0.036 |
| 85% | 90.4 ± 3.1 | 90.5 ± 3.0 | 0.444 ± 0.182 | 0.172 ± 0.028 |
| 100% | 102.1 ± 3.2 | 102.1 ± 3.2 | 0.553 ± 0.119 | 0.197 ± 0.015 |

Table 1 presents means and standard deviations of vibration amplitude and frequency, using the data from five trials for each vibration intensity, measured by both accelerometer and Optotrak. Pearson correlation, t-test, and Bland-Altman plots were used to assess the agreement of the means of vibration amplitude and frequency calculated using the accelerometer versus calculations from the gold standard (Optotrak) measurement.

TABLE 2
Results of the T-test and Pearsoncorrelation statistical analyses.

| | |
|---|---|
| t-test (p-value) | Pearson correlation (r) |

| Vibration | Amplitude | Frequency | Amplitude | Frequency |
|---|---|---|---|---|
| intensities | (mm) | (Hz) | (mm) | (Hz) |
| 55% | 0.39 | 0.996 | −0.14 | 0.999 |
| 65% | 0.04* | 0.999 | 0.72 | 1.000 |
| 75% | 0.95 | 0.415 | 0.89 | 0.999 |
| 85% | 0.03* | 0.979 | 0.36 | 0.999 |
| 100% | 0.00* | 0.997 | 0.75 | 1.000 |

*P < 0.05 indicating significant difference between the results of the two measurement methods.

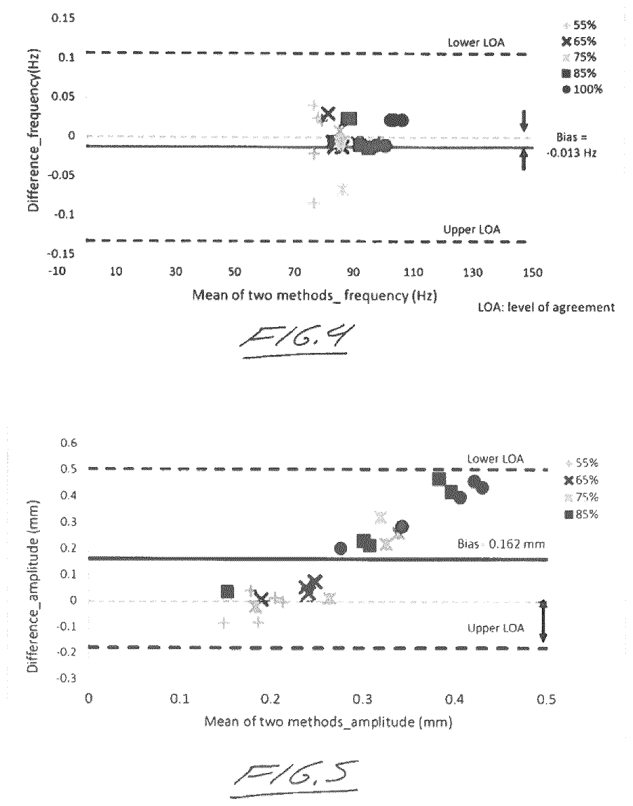

Pearson correlations showed a strong positive relationship between accelerometer and Optotrak measurements. A t-test showed no significant difference between the means of the measurements using the two methods (Table 2). The measurement bias was calculated as the mean of the differences between Optotrak and accelerometer measurements (Giavarina, 2015). The bias between the two measurements methods was as small as −0.013 (FIG. 4); the negative sign indicates that the accelerometer measurements were slightly higher. The interval between the upper and lower levels of agreement for frequency measurements was 0.24 Hz and the range of the vibration frequency measure by the Optotrak was 75-105 Hz. So, it seemed that sensitivity of accelerometer measurements for vibration frequency was acceptable. Pearson correlation showed strong correlation between displacement measurements of the accelerometer and Optotrak for 65%, 75%, and 100% vibration intensities, however t-tests revealed a significant difference (p<0.05) between the accelerometer and Optotrak measurements (Table 2). The measurement bias for vibration amplitude was 0.162 mm (FIG. 5); the positive sign for the bias indicates that the accelerometer measurements were lower than the Optotrak. The interval between the upper and lower levels of agreement for the vibration amplitude measurements using the accelerometer was 0.684 mm. So, given that the range of displacement measured for the current vibration motors, as measured with the Optotrak, were as small as 0.1-0.6 mm, sensitivity of accelerometer measurements for amplitude of vibration did not seem acceptable. FIG. 5 presents the Bland-Altman plots for vibration amplitude. Since there is a linear pattern for the vibration amplitude measurements from the two methods, the next proposed step was to model the linear relationship between the displacement measurements with the two methods and use this model for estimating the actual vibration amplitude using the accelerometer measurements to minimize the measurement error.

In conclusion, the results of the case study showed that accelerometer measurements could be validated for vibration frequency measurements, though accelerometer measurements for vibration amplitude could not be validated with the Optotrak measurements. In order to use Optotrak for measuring the characteristics of MTV during an experiment, the vibration motor has to be in a stationary position in an optimal position relative to the camera, which makes it a difficult posture for the participants to maintain. Moreover, equipment such as Optotrak is not available or feasible in a clinical setting. The present invention instead advantageously uses an accelerometer to measure vibration characteristics. Beside lower costs and availability, accelerometers are light weight, small, and can be easily embedded within wearable devices for installing the vibration motors on the participant limb. The results of the case study showed that affordable accelerometers are capable of measuring vibration frequency with high precision, with additional modeling being proposed as further work to verify that the accelerometers are also capable of estimating the vibration amplitude.

Since various modifications can be made in the invention as herein above described, and many apparently widely different embodiments of same may be made, it is intended that all matter contained in the accompanying specification shall be interpreted as illustrative only and not in a limiting sense.

### REFERENCES

Aman, J. E., Elangovan, N., Yeh, I. L., & Konczak, J. (2014). The effectiveness of proprioceptive training for improving motor function: a systematic review. Front Hum Neurosci, 8, 1075. doi:10.3389/fnhum.2014.01075

Bland, M. J., & Altman, D. G. (1986). STATISTICAL METHODS FOR ASSESSING AGREEMENT BETWEEN TWO METHODS OF CLINICAL MEASUREMENT. The Lancet, 327(8476), 307-310. doi: https://doi.org/10.1016/S0140-6736(86)90837-8 Giavarina, D. (2015). Understanding bland altman analysis. Biochemia medica: Biochemia medica, 25(2), 141-151.

Mortaza, N., Abou-Setta, A., Zarychanski, R., Loewen, H., Rabbani, R., & Glazebrook, C. M. (2019). Upper limb tendon/muscle vibration in persons with subacute and chronic stroke: a systematic review and meta-analysis. Eur J Phys Rehabil Med. doi:10.23736/S1973-9087.19.05605-3

Roll, J. P., & Vedel, J. P. (1982). Kinaesthetic role of muscle afferents in man, studied by tendon vibration and microneurography. Exp Brain Res, 47(2), 177-190.

Roll, J. P., Vedel, J. P., & Ribot, E. (1989). Alteration of proprioceptive messages induced by tendon vibration in man: a microneurographic study. Exp Brain Res, 76(1), 213-222. doi:10.1007/bf00253639

1. A wearable rehabilitation device comprising:
a wearable support sized and shaped for worn fitting thereof over a body part of a patient; and
supported on said wearable support:
one or more vibratory stimulators operable to stimulate muscle tendon tissue of said body part of the patient; and
one or more accelerometers configured to generate output signals responsive to vibration of said one or more vibratory stimulators.

2. The device of claim 1 wherein said one or more vibratory stimulators comprises two vibratory stimulators positioned to respectively overlie two different muscle tendons of said body part.

3. The device of claim 2 wherein said one or more accelerometers comprises two accelerometers, each of which is configured to generate a respective output signal responsive to vibration of a respective one of said two vibratory stimulators.

4. The device of claim 2 wherein said two vibratory stimulators are positioned on said wearable support at positions selected to respectively overlie flexor and extensor muscle tendons of said body part.

5. The device of claim 1 comprising a controller that is configured to receive user input signifying a targeted vibrational frequency of said one or more vibratory stimulators, to receive said output signals from the one or more accelerometers and derive therefrom a measured vibrational frequency of said one or more vibratory stimulators, and is configured to compare said measured vibrational frequency against said targeted vibrational frequency.

6. The device of claim 5 wherein said controller is configured to control operation of said vibrational stimulators, and to vary one or more operating conditions thereof based on detected disagreement between said measured vibrational frequency and said user input.

7. The device of claim 5 wherein said controller is configured to vary an operating voltage applied to said vibrational stimulators based on said detected disagreement.

8. The device of claim 6 wherein said controller is configured to output a confirmation signal upon detected agreement between said measured vibrational frequency and said user input.

9. A wearable rehabilitation device comprising:
a wearable support sized and shaped for worn fitting thereof over a body part of a patient; and
supported on said wearable support:
a first vibratory stimulator positioned on said wearable support at a first location thereon that is arranged to overlie a first muscle tendon of said body part of the patient when said wearable support is donned in a worn position thereon; and
a first vibratory stimulator positioned on said wearable support at a second location thereon that is arranged to overlie a second muscle tendon of said body part of the patient when said wearable support is donned in the worn position thereon.

10. The device of claim 9 wherein said first and second vibratory stimulators are positioned on said wearable support body at positions selected to respectively overlie flexor and tensor muscle tendons of said body part.

11. The device of claim 1 wherein said wearable support comprises a wristband.

12. The device of claim 1 wherein each vibratory stimulator is relocatable among different positions on said wearable support.

13. The device of claim 1 wherein said wearable support is adjustable in size.
